(19) United States
(12) Patent Application Publication
(10) Pub. No.: US 2008/0047653 A1
(43) Pub. Date: Feb. 28, 2008

(54) METHOD FOR MANUFACTURING MULTI-LAYER CERAMIC SUBSTRATE

(76) Inventors: Kan Shih-Wei, Jhongli City (TW); Yu Chieh-Kuang, Yingge Township (TW)

Correspondence Address: DENNISON, SCHULTZ & MACDONALD, 1727 KING STREET, SUITE 105, ALEXANDRIA, VA, 22314, US

(21) Appl. No.: 11/467,702

(22) Filed: Aug. 28, 2006

(51) Int. Cl. C03B 29/00; B32B 38/04

(52) U.S. Cl. 156/89.11; 156/264; 156/272.8; 156/89.12; 156/89.16

(57) ABSTRACT

The present invention relates to a method for manufacturing multi-layer ceramic substrate, a plurality of aluminum oxide ceramic substrate units are piled together, between each two ceramic substrate units is an oxide medium layer which can grow crystal grain during sintering. Such that the upper and lower ceramic substrate units will compactly bind together with the oxide medium layer because the grown crystal grains enter into the gaps or holes formed between the crystal grains of the surfaces of ceramic substrate units during sintering process.

### BACKGROUND OF THE INVENTION

1. Field of the invention

The present invention relates to a method for manufacturing multi-layer ceramic substrate, particularly to a method for manufacturing multi-layer ceramic substrate which can ensure the size of sintered multilayer ceramic substrate, largely reduce manufacturing processes, producing costs and defective fraction.

2. Description of the Prior Art

It is known to public that the thick film hybrid circuits are printed on the surface of single-layer or interior parts of multi-layer ceramic substrates. The materials used in ceramic substrates include: substrate materials, conductive materials, resistant materials, dielectric materials, and package materials etc. The single-layer thick film circuits apply a method of forming the electronic circuits onto the surface of ceramic substrate, while the hybrid ceramic substrate is formed by cofiring electronic circuits with substrate materials.

In order to increase the densities of chips on substrates, reduce the lengths of conductors connecting chips, and reduce the capacitance functions between internets, so as to increase the reliability of electronic circuits and obtain the request of light in weight, small in size for modern electronic products. The multi-layer substrate module has been widely used. The multi-layer substrate module is formed by using the technique of preparing a plurality of green tapes of substrates needed for producing multi-layer thin film modules, and then cofire the said plurality of embryo substrates to form the multi-layer ceramic substrate modules. According to the firing temperatures, the processes for forming multi-layer ceramic substrate modules can be divided as high temperature cofire ceramic (HTCC, >1000° C.) and low temperature cofire ceramic (LTCC, <1000° C.)

The conventional method for producing multi-layer ceramic substrate modules having hybrid electronic circuit are shown as FIG. 1 and comprising the following steps:

1. The grinding step 101 of mixing the ceramic raw materials and grinding it into ceramic micro powders;

2. The gas removing step 102 of removing the gaseous bubbles inside the ceramic micro powders;

3. The casting step 103 of modeling the ceramic micro powders;

4. The punching step 104 of forming the modeled ceramic micro powders into green tapes of ceramic substrate;

5. The step 105 of forming layout pattern of electronic circuit by printing or etching technique;

6. The step 106 of piling said plurality of green tapes of ceramic substrates having electronic circuit layout pattern and laminating all of artifact green tapes of ceramic substrates to form multi-layer ceramic embryo substrate;

7. The step 107 of cutting the multi-layer ceramic embryo substrate obtained in step 106 into a plurality of separable unit substrates having the same size;

8. The sintering step 108 of sintering the said multi-layer ceramic embryo substrate having a plurality of cutting lines to obtain cured multi-layer ceramic substrate;

9. The testing step 109 of testing the quality of the sintered and cured multi-layer ceramic substrate;

10. The measuring and modification step 110 of measuring the dimensions of the cured and qualified multi-layer ceramic substrates and then modify it if necessary;

11. The retesting step 111 of retesting the cured multi-layer ceramic substrates having qualified dimensions;

12. Finally, in the step of 112 the cofired multi-layer ceramic substrate is obtained.

The conventional multi-layer ceramic substrate module manufactured by high temperature cofiring process must have a substrate having 96% of aluminum oxide at least. Because it has to be heated under the temperature higher than 1400° C., the conductive materials (mainly are the electric conductive materials such as tungsten, platinum etc.) are easy to be oxidized, such that the substrate has to be heated to growth under the reduce atmosphere of hydrogen. In comparison with the high temperature cofire ceramic (HTCC) and thick film process, the low temperature cofire ceramic (LTCC) is more suitable for preparing multi-layer ceramic substrates in high density and high speed. The low temperature cofire ceramic modules are sintered under the temperature below 1000° C. and the atmosphere of common air by using glass and aluminum oxide as substrate materials. And the conventional electric resistant and conductive materials can be used in multi-layer substrate module obtained by low temperature sintering. While the electronic elements such as conductive wires, resistors and capacitors etc. can be formed inside the multi-layer ceramic substrate or directly formed on the surface of substrate, so as to increase the densities of electric circuit and electric elements, such that the spaces for passive elements would be reduced and the dimensions of substrate also can be lessened.

However, since the conventional multi-layer ceramic substrate are obtained by sintering the embryos, the time for manufacturing multi-layer ceramic substrate are very long and the processes are very complicated, as a result, the cost is highly increased and, the conventional methods can not control the uniform dimensions of multi-layer ceramic substrate, the yield of product then is not stable.

### SUMMARY OF THE INVENTION

Accordingly, the present invention has been made to solve the above-mentioned problems occurring in the prior art, and an object of the present invention is to provide a method for manufacturing multi-layer ceramic substrate, so as to ensure the size of the cured multi-layer ceramic substrate is qualified, and then greatly reduce the manufacture time and cost.

According to the above object, the method of present invention is to pile a plurality of cured aluminum oxide ceramic substrate units together, between each of two cured ceramic substrate units is an oxide medium layer which can grow crystal grain during sintering, then the piled cured aluminum oxide ceramic substrate units having oxide medium layer between each two substrate units is put into sintering furnace to proceed a sintering. Such that the upper and lower ceramic substrate units will completely bind together with the oxide medium layer because the grown crystal grains enter into the gaps or holes between the crystal grains of the surfaces of ceramic substrate units during sintering process.

### BRIEF DESCRIPTION OF THE DRAWINGS

FIG. 1 is a flow chart showing the conventional method for manufacturing multi-layer ceramic substrate

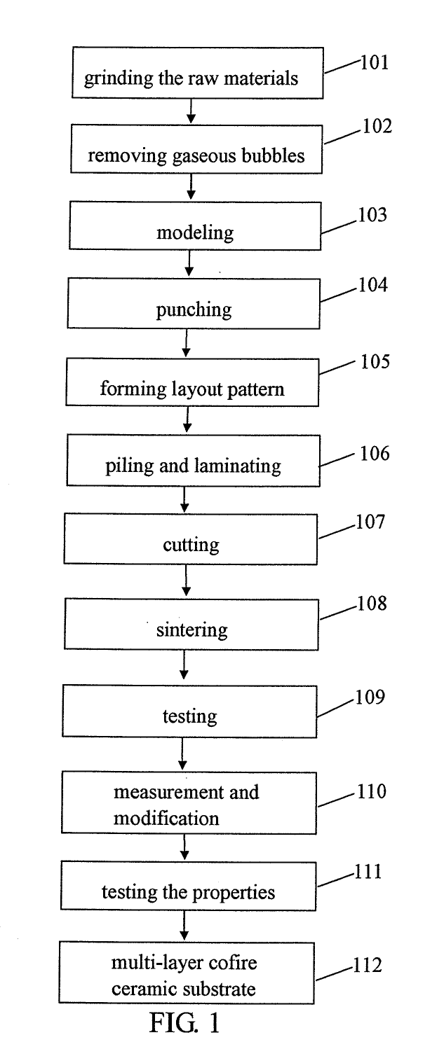

FIG. 2 is a flow chart showing a preferred embodiment of the present invention;

FIG. 3 is a photograph showing the surface construction of the cured ceramic substrate unit obtained in the first stage of the method of present invention;

FIG. 4 is a perspective view showing the multi-layer ceramic substrate obtained by the method of present invention;

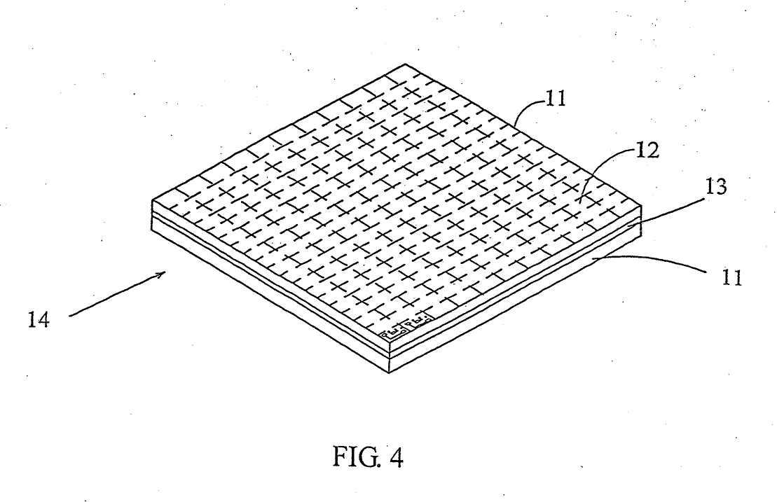

FIG. 5 is a separated perspective view showing the construction of the multi-layer ceramic substrate obtained by the method of present invention; and

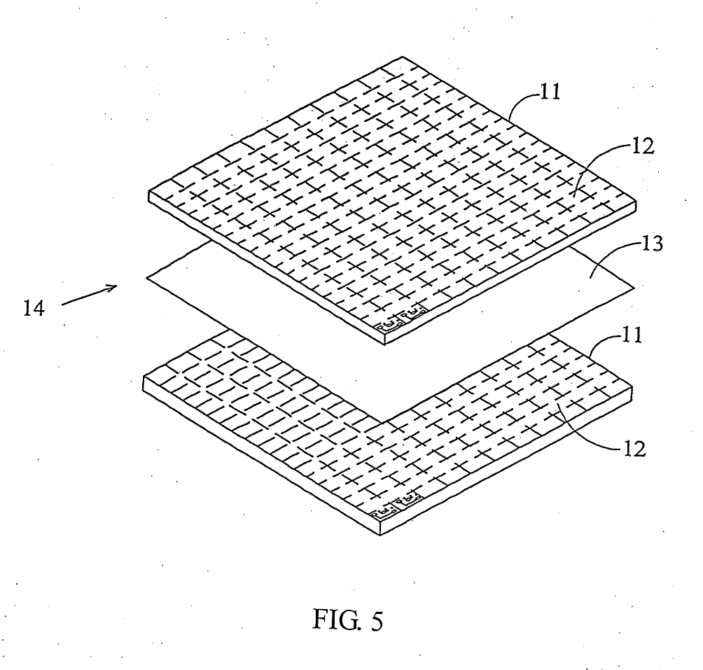

FIG. 6 is a cross-sectional view showing the crystalline construction of the multi-layer ceramic substrate obtained by the method of present invention.

### DETAIL DESCRIPTION OF THE PREFERRED EMBODIMENTS

### Example 1

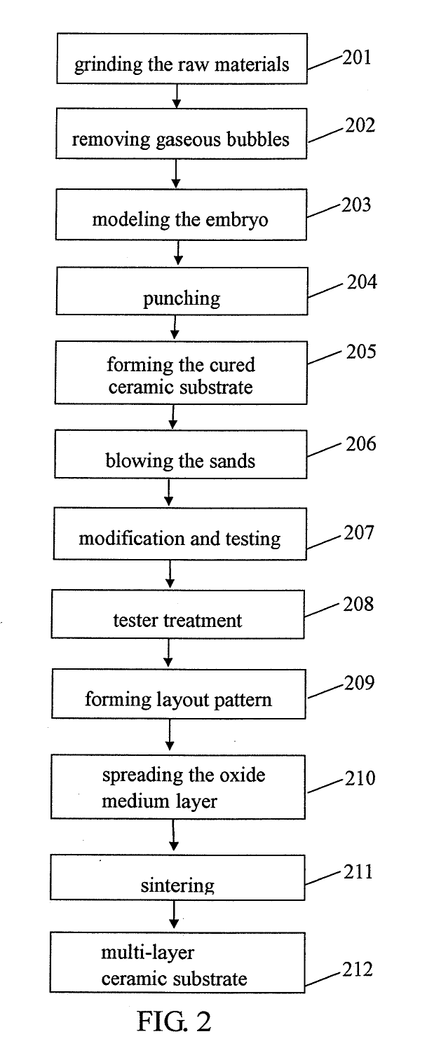

Please refer to FIG. 2, the first example of the method for manufacturing multi-layer ceramic substrate of present invention uses two stages to complete the manufacture of multi-layer ceramic substrate, they are now described as follows:

A. The first stage: preparation of cured ceramic substrate units.

Step 1 (201): Mixing the ceramic raw materials and grinding it into ceramic micro powders by ball mill or other grinding equipment, preferably, the ceramic raw materials are containing at least 96% of aluminum oxide (Al₂O₃), its properties are shown in table 1;

TABLE 1

| | |
|---|---|
| Al₂O₃ Content (%) | ≧96% |
| Color | white |
| Flexural strength (Mpa) | ≧300 |
| Density (g/cm₃) | ≧3.72 |
| Surface roughness (μm) | ≦4 |
| Thermal conductivity (25° C.) | 22.3 w/m ° K |
| Thermal expansion coefficient | ≦8.0 * 10⁻⁶1/° C. |
| (20~800° C.) | |
| Dielectric strength | ≈10 |
| Insulating tolerance (KV/mm) | ≦10 |
| Volume resistivity (25° C.) | >10¹⁴ Ω · cm |
| Loss index (1 MHz) | ≦4 * 10⁻³ |

Step 2 (202): Removing the gases or gaseous bubbles inside the ceramic micro powders obtained in step 1 by drying apparatus;

Step 3 (203): Mixing the ceramic micro powders without gases or gaseous bubbles obtained in step 2 with organic binders and stirring the mixture, and then flow the mixtures onto a basic film to form the ceramic green tape;

Step 4 (204): Punching the thin ceramic raw plate obtained in step 3 into molded ceramic green tape having same dimensions by a mold, then the ceramic substrate embryo is obtained;

Step 5 (205): Sintering the ceramic substrate embryo obtained in step 4 by a sinter furnace with a proper temperature, then a cured ceramic plate is obtained;

Step 6 (206): Blowing the micro sands onto the surface of cured ceramic plate obtained in step 5, then the roughness of the surface of cured ceramic plate is uniform and a numerous micro holes are formed on the surface, such that it is advantageous for the performance of the second stage;

Step 7 (207): Modifying and testing the cured ceramic plate having uniform roughness on its surface obtained in step 6, if the size and properties of the cured ceramic plate are qualified, then it is a cured ceramic substrate unit needed for forming the multi-layer ceramic substrate by the second stage.

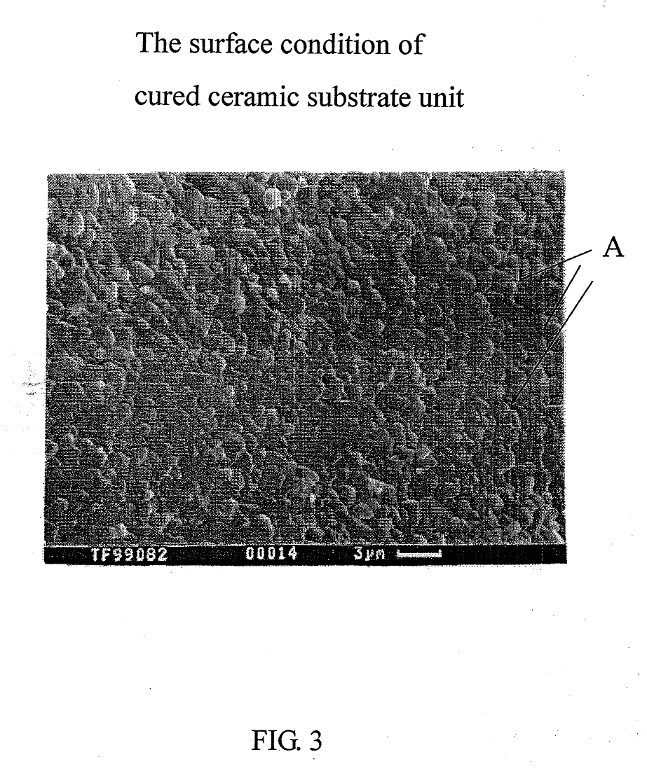

As shown in FIG. 3, the cured ceramic substrate unit has a lot of gaps or holes “A” between the crystal grains. It is then advantageous for forming a multi-layer ceramic substrate in the second stage.

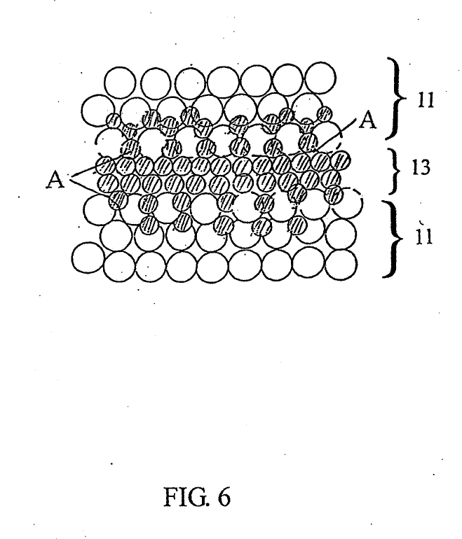

Please refer to FIG. 2 and FIG. 6, the second stage of forming the multi-layer ceramic substrate of present invention is described as follows:

B. The second stage: formation of multi-layer ceramic substrate.

Step 8 (208): Using the technique of laser treatment etc. to form a plurality of cutting lines on the surface of the cured ceramic substrate unit 11 obtained in step 7, and then the cured ceramic substrate unit 11 is divided into a plurality of separatable unit substrates 12;

Step 9(209): Forming the layout pattern of electronic circuit or electronic elements such as conducting wires, resistors and capacitors etc. by the technique of photo-mask etching, printing etc. onto the cured ceramic substrate unit 11 having a plurality of cutting lines obtained in step 8;

Step 10 (210): Piling a plurality of cured ceramic substrate units 11 having electronic circuit layout pattern obtained in step 9. And, between each two cured ceramic units 11 is an oxide medium layer 13 which can grow crystal grains in the process of sintering;

Step 11(211): Putting the piled cured ceramic substrate units 11 having oxide medium layer 13 which can grow crystal grains between each two of them into furnace and proceed sintering, then the piled cured ceramic substrate units 11 shall get together tightly to form a multi-layer ceramic substrate 14 because of the function that the grown crystal grains of oxide medium layer 13 enter into the gaps or holes “A” on the surface of cured ceramic substrate units;

Step 12 (212): Testing the properties of the multi-layer substrate units 11 obtained in step 11, then a qualified multi-layer substrate is obtained for professional uses.

As shown in above, the method for manufacturing multi-layer ceramic substrate of present invention does not need complicated operational processes, it is then can greatly reduce the manufacturing costs. In addition, because the multi-layer ceramic substrate is obtained by sintering cured ceramic substrate units, rather than the ceramic substrate embryos, then the ceramic substrate units shall not cause the changes of their dimensions, the obtained multi-layer ceramic substrate 14 is very stable not only in its dimension, but also in its properties. The yield of product then is greatly increased.

In the above examples, the layout pattern of electronic circuits or electronic circuits etched or printed onto each of the unit substrate 12 can be a hybrid circuit.

Furthermore, in the above mentioned examples, said oxide medium layer 13 is a low temperature (below 1000° C.) sintering medium, while said cured ceramic substrate unit 11 can be cured aluminumoxide (Al₂O₃) substrate; when the piled ceramic substrate units 11 are performed in sintering by the growth of crystal grains of said oxide medium layer 13, and the grown crystal grains enter into the gaps or holes “A” between the crystal grains of the surface of cured ceramic substrate units 11, then the crystal grains of the surface of cured ceramic substrate units 11 compactly bind together with the crystal grains grown by oxide medium layer 13, a multi-layer ceramic substrate having compact structure then is formed.

### Example 2

In an another example of the present invention, because the multi-layer ceramic substrate can be of different constructions depend on different applications or necessities. It is then may not form layout pattern of electronic circuit on the surface of cured ceramic substrate unit.

Then in the method for manufacturing multi-layer ceramic substrate of Example 1, if the step 9 (209) is omitted and the layout pattern of electronic circuit is not formed on the cured ceramic substrate unit 11, then it is an another example of present invention.

In conclusion from above, the method for manufacturing multi-layer ceramic substrate of present invention is a method never has been seen in conventional techniques, it not only has not been seen in any published paper or journal, there is also nothing with similar construction of the multi-layer ceramic substrate obtained by the method of present invention has been sold in the market. Consequently, the present invention is deemed to be new without any doubt. In addition, the multi-layer ceramic substrate obtained by the present invention has the features and functions that have never been found in conventional goods, then the present invention is deemed having contained progressiveness and complies the condition of approvable patents.

Although the present invention has been described with a certain degree of particularity, the present disclosure has been made by way of example and changes in details of structure may be made without departing from the spirit thereof.

What is claimed is:

1. A method for manufacturing multi-layer ceramic substrate, comprising the steps of:
(a). Preparing a plurality of cured ceramic substrate units formed by the material of aluminum oxide and using the technique of laser treatment etc. to form a plurality of cutting lines on the surface of the cured ceramic substrate unit, and then the cured ceramic substrate unit is divided into a plurality of separatable unit substrate;
(b). Forming the layout pattern of electronic circuit or electronic elements such as conducting wires, resistors and capacitors etc. by the technique of photo-mask etching, printing etc. onto the cured ceramic substrate unit having a plurality of cutting lines;
(c). Piling a plurality of cured ceramic substrate units having electronic circuit layout pattern obtained in step (b), and, between each two cured ceramic units is an oxide medium layer which can grow crystal grains in the process of sintering; and
(d). Putting the piled cured ceramic substrate units having oxide medium layer which can grow crystal grains between each two of them into furnace and process sintering, then the piled cured ceramic substrate units shall get together tightly to form a multi-layer ceramic substrate.

2. A method for manufacturing multi-layer ceramic substrate, comprising the steps of:
(A). Preparing a plurality of cured ceramic substrate units formed by the material of aluminum oxide;
(B). Piling a plurality of cured ceramic substrate units, and, between each two cured ceramic units is an oxide medium layer which can grow crystal grains in the process of sintering; and
(C). Putting the piled cured ceramic substrate units having oxide medium layer which can grow crystal grains between each two of them into furnace and process sintering, then the piled cured ceramic substrate units shall get together tightly to form a multi-layer ceramic substrate.

3. The method as claimed in claim 1, wherein the sintering temperature is below 1200° C.

4. The method as claimed in claim 2, wherein the sintering temperature is below 1200° C.

5. The method as claimed in claim 1, wherein the said oxide medium layer can grow crystal grains below the temperature of 1200° C.

6. The method as claimed in claim 2, wherein the said oxide medium layer can grow crystal grains below the temperature of 1200° C.

7. The method as claimed in claim 1, wherein the material of cured ceramic substrate unit is aluminum oxide.

8. The method as claimed in claim 2, wherein the material of cured ceramic substrate unit is aluminum oxide.
